(19) United States
(12) Patent Application Publication
(10) Pub. No.: US 2009/0273441 A1
(43) Pub. Date: Nov. 5, 2009

(54) SYSTEM AND METHOD FOR ADJUSTING COMPONENTS WITHIN AN OFFICE SPACE

(75) Inventor: Maharaj Mukherjee, Wappingers Falls, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/115,041

(22) Filed: May 5, 2008

(51) Int. Cl. G05B 19/045

(52) U.S. Cl. 340/5.82

(57) ABSTRACT

A method for adjusting the components within an office space includes adjusting to a preferred setting at least one of a plurality of physical features of at least one of a plurality of components for at least one of a plurality of persons; and storing the preferred setting for the at least one person. One of the persons is identified from information about that person (e.g. biometric information), and for the identified person at least one of the physical features of at least one of the components is adjusted to the preferred setting.

### BACKGROUND

The present invention relates generally to office work environments and, more particularly, to a system and method for adjusting a plurality of components within an office space.

In an office work environment exposure for extended periods of time to less than optimal or to physically uncomfortable working conditions (e.g., when seated and typing at a computer keyboard) can lead to fatigue, lack of productivity, emotional distress and various types of personal injuries (e.g., carpal tunnel syndrome, lower back pain or other physical problems) and, thus, reduced productivity or even lost work hours. This can occur even when the office worker believes he/she feels comfortable with the then-current settings or positions of the various features of the components within the office environment. That is, the office worker can still incur injury even if he/she feels that they are ergonomically or physically comfortable within their work environment.

Some components of the office environment, such as office chairs, are manually adjustable for one or more of the physical features of the chair. For example, turning a dial or moving a lever may manually adjust the height of the chair seat above the floor. Other physical features of the chair that are typically manually adjustable include the inclination and tension of the seat back, the depth and height of the lumbar support area on the seat back, the height aid arm angle of the armrests, and the height and tilt angle of the headrest. Similarly, a personal computer may have several of its physical features manually adjustable, such as the height and tilt angle of the keyboard, the distance of the keyboard from the visual display monitor, and the tilt angle of the visual display monitor. Also, the desk upon which the computer monitor and keyboard are often located may also have several of its physical features manually adjustable, for example the height of the top work surface of the desk from the floor, and the depth of the keyboard tray and its length from the desktop.

However, oftentimes these manual adjustments, when available, of the various physical features of the several components within the office space environment are awkward, time consuming and somewhat of a “hit or miss” procedure in achieving accuracy of the desired or most comfortable settings. As a result office workers often tend not to adjust some or all of the features of the various components, in part because they feel it is not worth the effort. This is so even for the office that the worker spends most of his/her time in (i.e., their “fixed” or “home” office).

In many work environments office workers are not assigned a fixed office. For example, an airline ticketing or check-in agent may move from one counter to another several times in the course of a day. In some other cases, offices are assigned to a person only on a daily basis. This practice of assigning offices on a daily basis is often referred to as hoteling. Hoteling (also called office hoteling) is the practice of providing office space to employees on an as-needed basis rather than on the traditional, constantly reserved basis. This reduces the amount of physical space that an enterprise needs, lowering overhead cost while (ideally) ensuring that every worker can access office resources when necessary.

A hoteling system may include a reservation program that anticipates demand, manages how to meet the demand when it occurs, and prevents resource hoarding (i.e., the making of just-in-case reservations to ensure space is always available, whether needed or not). Employees can retain their own telephone number extension and voice mailbox. Hoteling systems can be especially useful to enterprises in which employees travel frequently. Remote offices can exist almost anywhere, equipped with ports for notebook computers. Some companies provide special rooms, designed specifically for hoteling, equipped with tables, chairs, computers and other office equipments. The practice of office hoteling is used to advantage by diverse businesses including real estate agencies, consulting firms, law firms, manufacturers' representatives, telecommuters, and flex-time workers.

If an office worker occasionally or frequently travels to other offices, or moves from one office space to another, however near or remote from their home office, that worker likely will not make any manual adjustments to the physical features of the various components within different offices, for various reasons (e.g., the physical features of the office components may already be adjusted for the person that normally occupies that office and the traveler may not want to disturb those settings). Moreover, even if the employee tries to adjust the office equipments as and when he or she moves into a different office location, it would take a significant amount of their working hours and reduce productivity. As a result oftentimes the worker will not or does not work in the remote office in ergonomically comfortable conditions, which could lead to fatigue, lack of productivity and/or physical injury.

### SUMMARY

The foregoing discussed drawbacks and deficiencies of the prior art are overcome or alleviated, in an exemplary embodiment, by a method for adjusting components within an office space, the method including adjusting to a preferred setting at least one of a plurality of physical features of at least one of a plurality of the components for at least one of a plurality of persons; storing the preferred setting for the at least one person; identifying one of the persons from information about that person; and for the identified person adjusting at least one of the physical features of at least one of the components to the preferred setting.

In another embodiment, a computer program product includes a computer readable computer program code for implementing adjusting of components within an office space; and instructions for causing a computer to implement a method for adjusting components within an office space, the method further including adjusting to a preferred setting at least one of a plurality of physical features of at least one of a plurality of the components for at least one of a plurality of persons; storing the preferred setting for the at least one person; identifying one of the persons from information about that person; and for the identified person adjusting at least one of the physical features of at least one of the components to the preferred setting.

A system for adjusting components within an office space includes a computing network including a processing device in communication with one or more computer memory storage devices; and the computer network further configured to implement a method for adjusting components within an office space, the method further including adjusting to a preferred setting at least one of a plurality of physical features of at least one of a plurality of the components for at least one of a plurality of persons; storing the preferred setting for the at least one person; identifying one of the persons from information about that person; and for the identified person adjusting at least one of the physical features of at least one of the components to the preferred setting.

### BRIEF DESCRIPTION OF THE DRAWINGS

Referring to the exemplary drawings wherein like elements are numbered alike in the several Figures:

FIG. 1 is a schematic diagram of an office space having components adjustable in accordance with an exemplary embodiment of the present invention:

FIG. 2 is a block diagram of an office chair within the office space of FIG. 1, where the chair has various adjustable physical features:

FIG. 3 illustrates a side view of a keyboard that is part of a computer within the office space of FIG. 1, where the keyboard has an adjustable tilt angle;

FIG. 4 is a block diagram that illustrates the steps carried out in a general methodology of the implementation of the exemplary embodiment of the present invention illustrated in FIGS. 1-3; and

FIG. 5 is a schematic block diagram of a general-purpose computer suitable for practicing embodiments of the present invention.

### DETAILED DESCRIPTION

Disclosed herein is a system and method for adjusting components within an office space. Briefly stated, the various physical features of a plurality of components (e.g., chair, desk computer, etc.) within the office space are adjusted automatically and/or manually for “best case” (i.e., relatively most comfortable and/or relatively least likely to cause physical injury) ergonomic positioning or setting for each one of the various persons that will work in that particular office space. The settings for each person are stored in a memory that may be part of a computer. The settings may be encrypted for privacy and may be accessible only to certain persons. When a person who has had his/her settings stored in the computer memory then desires to work in the office space, that person is identified from information about that person (e.g., biometric information) and the various physical features of the office space components are automatically adjusted as necessary to match the stored settings for that particular person.

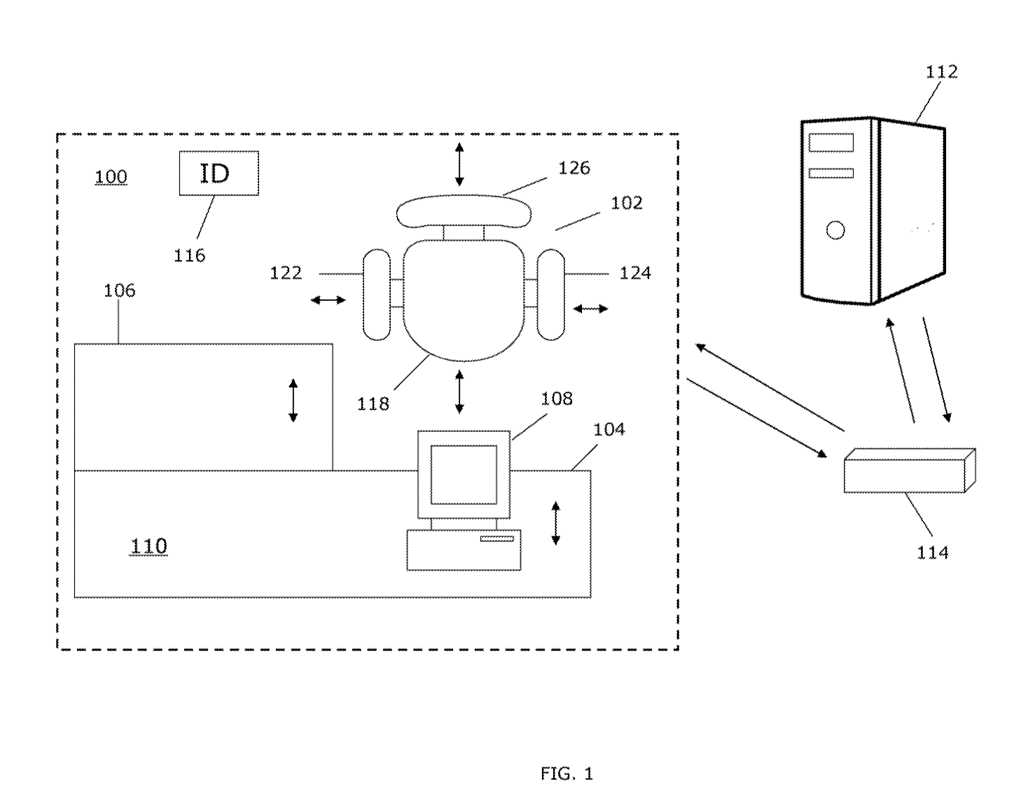

Referring to FIG. 1, there is shown a schematic diagram of an office space 100 in accordance with an exemplary embodiment of the present invention. The office space 100 includes various components each with physical features that are ergonomically adjustable preferably in an automatic manner, as described in detail hereinafter. The components may include a chair 102, a desk 104 with a side extension 106, and a computer 108 located on a top work surface 110 of the desk 104. The arrowheads shown in FIG. 1 illustrate the typical directions of movements of these features. The office space 100 may include other components besides those illustrated in FIG. 1. These other components may or may not have features that are adjustable in accordance with the present invention. If these other components do include features that are adjustable, then such features may also be adjusted in accordance with the system and method of the present invention, in light of the teachings herein.

FIG. 1 also illustrates a computer device 112, such as a server or a personal computer. As shown in FIG. 1 the server 112 may be located at another location within the overall office or building that the particular office space 100 resides in. In the alternative, the server 112 may be located within the particular office space 100, or the server 112 may be located remotely from the building and connected through the office 100 or the building by the Internet or the company's intranet. If the server 112 functions as a server for the entire or a large portion of the overall office, then typically one or more network gateway devices 114, such as a router, are utilized to communicate, either wirelessly or using wires or using remote connections, between the server 112 and the computer 104 and also with the adjustable components 102-108 within each associated office space 100.

Further, an identification reader 116, such as a badge reader, a biometrics sensor or some other type of personnel identification device may be used to identify the current occupier of the office. The reader 116 works in conjunction with some type of identification device carried on a person that uniquely identifies that person (e.g., an employee's badge) or, if biometrics is utilized, the reader 116 scans one or more physical attributes of the person, such as his/her fingerprints or retinas to make an identification of that person. The device 116 may be positioned near the entrance or within close proximity of the office or it may be placed somewhere remotely from the office space 100. In the latter case, the device 116 may communicate with the server 112 by some remote communication means. Alternatively, the identity of the present occupier of the office can be inputted within the server 112 manually by either the occupier himself/herself or by an authorized representative. In another alternative, the identity of the present occupier of the office can he inputted within the server 112 from a database or a table that lists each occupier for an office space for the assigned time slot.

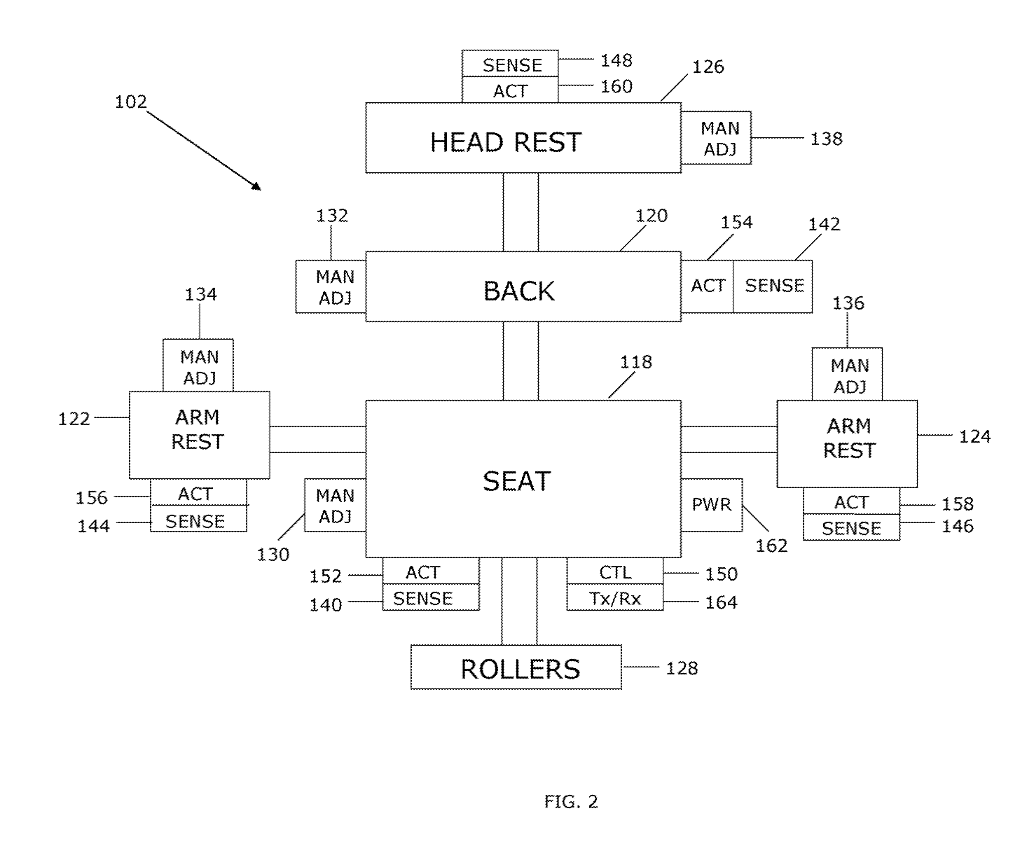

Referring also to FIG. 2, there illustrated is a block diagram of the chair 102 within the office space of FIG. 1. The chair 102 includes a number of physical features, some of which are adjustable in one or more directions. For example, the chair 102 includes a seat 118, a back 120, left and right armrests 122, 124, a headrest 126, and a set of rollers 128 in contact with the floor. For several of these physical features 118-126 of the chair 102, corresponding mechanical manual adjustment devices 130-138 are typically provided in a conventional manner, such as levers or dials. Manual actuation of these devices 130-138 allows the user of the chair 102 to adjust the setting of each of the corresponding physical features 118-126 of the chair 102 (e.g., adjust the vertical distance of the seat 118 with respect to the floor).

FIG. 2 also illustrates that, in accordance with an exemplary preferred embodiment of the present invention, each of the adjustable physical features 118-126 of the chair 102 also includes a corresponding sensor device 140-148 that automatically senses the then-current position of the corresponding feature. The sensors 140-148 may comprise any suitable type of sensor, such as a load sensor, a strain gage sensor, a potentiometer, a force sensitive resistor, a camera, or any other types of commonly known sensor that senses the presence or absence of a person with respect to that particular physical feature 118-126 (e.g., the person is sitting on the seat 118 of the chair 102) and/or the position (e.g., the angular inclination) of the person with respect to the feature. The sensors 140-148 transmit their respective sensed information to a central control unit 150, such as a microprocessor, mounted on or in the vicinity of the chair 102. Accordingly, each sensor 140-148 may be connected with the central control unit 150 by a wired connection.

Associated with each sensor 140-148 is a corresponding actuator 152-160 that moves the corresponding physical feature 118-126 of the chair 102 in one or more directions to achieve the desired physical position or setting of that feature. The actuators 152-160 may comprise, for example, a type of motor, such as a DC motor or a stepper motor, commercially available, or other types of biasing or actuating members such as springs or levers. If the actuators 152-160 are of the type such that the central control unit 150 knows the position of each actuator after having commanded that actuator to a desired position, then the sensors 140-148 may not be needed to practice the present invention. The actuators 152-160, and possibly some or all of the sensors 140-148, are connected to a corresponding power source 162 (e.g., a battery or fuel cell) mounted on the chair 102. A single power source 162 may be utilized to provide power to all of the devices mounted on the chair 102 (e.g., sensors 140-148, central control unit 150, actuators 152-160, etc.) that require such power for their operation. In the alternative, multiple power sources 162 may be provided on the chair 102, to thereby provide the various devices with their own dedicated power source. An example of an adjustable, electrically powered office chair is disclosed in U.S. Pat. No. 7,163,263. A transmit/receive device 164 that is preferably in wireless two-way communication with the server 112 via the router 114 may be provided as a separate device or as part of the central control unit 150. The transmit/receive device 164 enables the central control unit 150 to communicate with the server 112, as described in more detail hereinafter.

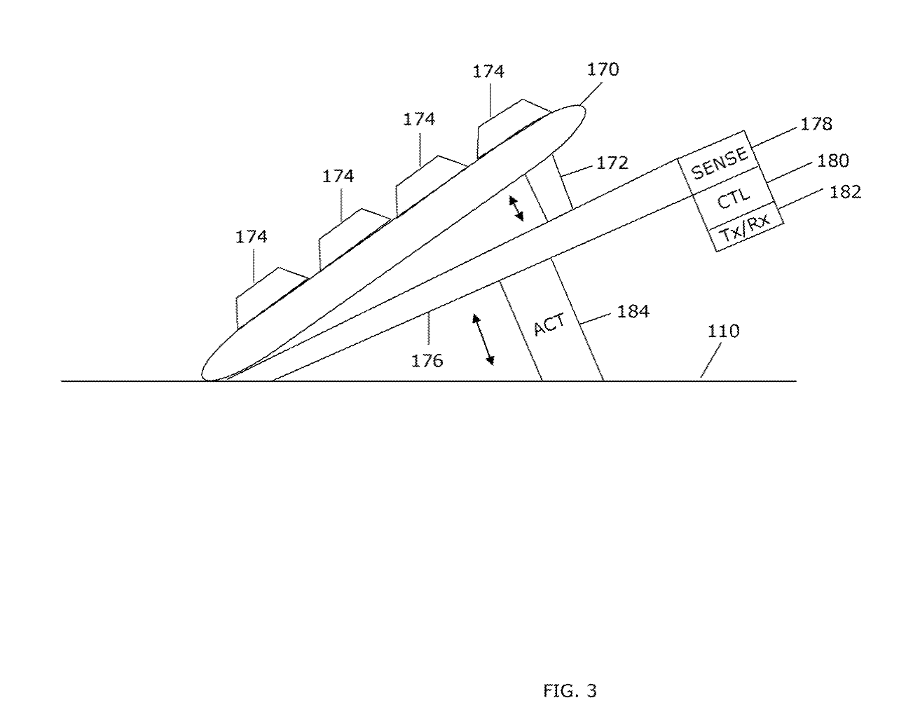

Similar to the chair 102, the desk 104 and portions of the computer 108 may have manual adjustment features that are well known in the art. For example, the desk 104 and its extension 106 may each have a plurality of feet that are rotatable to achieve a desired height of the desk 104 and extension 106, and, thus, the work surface 110. Also, the computer 108 may have a keyboard 170 (FIG. 3) whose angle with respect to the horizontal flat surface 110 of the desk 104 may be manually adjusted to one of several discrete positions by movable “feet” 172. Also the video display monitor may be hinged such that is may be tilted toward or away from the viewer. In conjunction with an exemplary embodiment of the present invention, some or all of these physical features of these components 104-108 within the office space 100 may be automatically adjustable simultaneously, similar to the chair 102 described above and illustrated in FIG. 2.

Referring to FIG. 3, there illustrated is a side view of the keyboard 170 that is part of the computer 108 within the office space 100. The keyboard 170 includes a plurality of keys 174, along with the manually adjustable “feet” 172 that may be moved in a conventional manner to adjust the tilt angle of the keyboard 170. In accordance with an exemplary embodiment of the present invention, a plate 176 is located beneath the keyboard 170 such that the manual feet 172, when extended from out under the bottom surface of the keyboard, contact the top surface of the plate 176. When the feet 172 are not extended out from the bottom of the keyboard 170, then the bottom of the keyboard contacts the plate 176. Attached to the plate 176 is a sensor 178 that senses the tilt angle of the keyboard and transmits this information to a control device 180, such as a microprocessor mounted, for example, to the plate 176. In turn, the control device 180 sends the keyboard position information to the server 112 (FIG. 1) via a transmit/receive device 182 that may he a separate device or integrated with the control device 180. FIG. 3 also illustrates an actuator 184 that adjusts the tilt angle position of the plate and, thus, that of the keyboard 170. The actuator 184 may be connected to the control device 180 for receiving its position commands therefrom. Thus, a user of the keyboard 170 may adjust the tilt angle of the keyboard 170 manually using the adjustable feet 172. The tilt angle of the keyboard 170 may also be further adjusted automatically by use of the sensor 178, control 180, actuator 184 and plate 176.

In a similar manner to the automatic adjustment of various physical features of the chair 102 illustrated in FIG. 2 and described hereinabove, and the automatic adjustment of the keyboard 170 illustrated in FIG. 3 and described hereinabove, other components within the office space may have their various physical features automatically adjustable as well, in light of the teachings herein. Such adjustments may be carried out through use of appropriate sensors, actuators and control devices, similar to those described and illustrated herein.

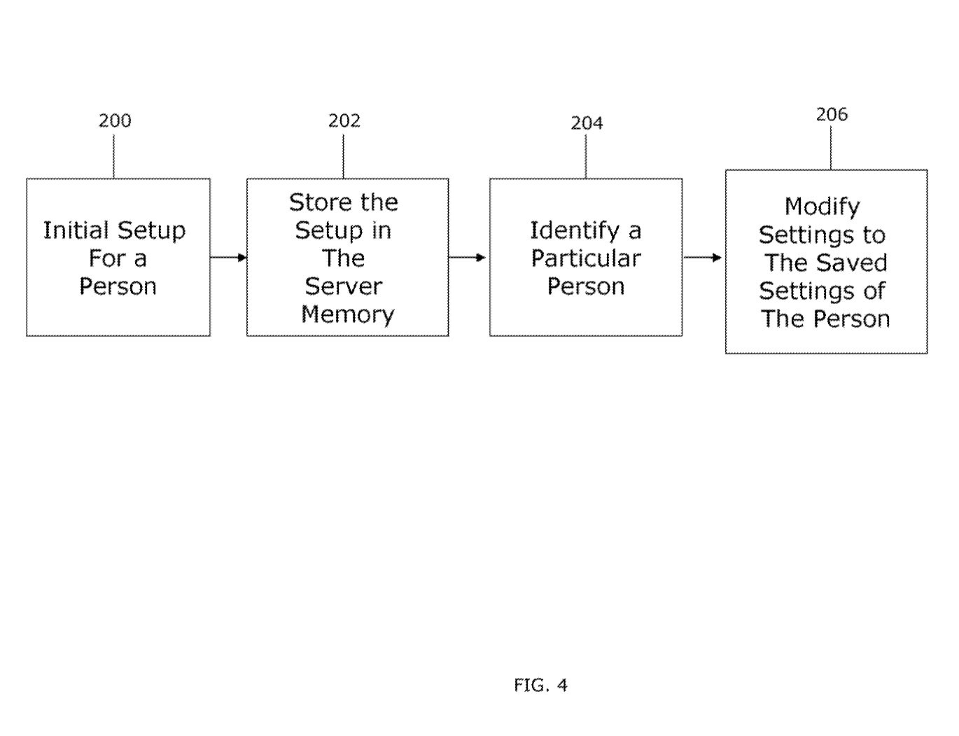

Referring to FIG. 4, there illustrated is a block diagram of various steps performed in an exemplary method embodiment, of the present invention. As shown in block 200, the various adjustable physical features of the one or more components (e.g., the chair 102) within the office space 100 are initially adjusted in an automatic manner when the person first sits down in the chair and moves to a comfortable and desired position with respect to the various features. It is to be noted that for the best comfort level of the occupier, each feature of the chair 102 is adjusted simultaneously in conjunction with each other. The comfort level of a particular person in turn depends on several biometric features of the occupier, such as height, weight, height of upper torso, length of legs and arms and distance from palm to elbow etc. Each of these biometric features in turn contributes to the optimal arrangements of the features 118-126.

The adjustments are carried out automatically through use of the various sensors 140-148 and/or actuators 152-160 described above and illustrated in FIGS. 1-3. The automatic adjustments may be augmented or “fine tuned” by the person through use of the conventional manual adjustments capabilities provided with each component. The result is an overall position of the person with respect to the various components within the office space 102. The settings of the various physical features of the components may then be stored in memory within the server 112 (FIG. 1), as shown in block 202. Also stored with these settings is an identification of the particular person who corresponds to these settings. These settings may be encrypted for privacy and accessible by only certain persons. The invention contemplates that a plurality of people will use any particular office space 102 that has the invention implemented therein. Therefore, each person who undergoes the initial setup step of block 200 may have an identification associated with the settings (e.g., an employee identification number), which may also be stored in the server memory.

Next, in block 204 when a particular person desires to work in the office space 100, that person is identified, for example, by the identification device 116 (FIG. 1). If that identified person has had his/her initial settings stored in the server memory, that person is essentially then “cleared” or authorized to work in the office space 102. In block 206, the initial settings for that person are retrieved from the server memory and utilized to adjust or modify the various physical features of the components within the office space 100, preferably simultaneously. Also, if for some reason the person currently occupying the office space 100 desires to make additional adjustments to any of the physical features of the components, the person can accomplish this through available manual adjustment devices that are conventional on the various components. These resulting modified settings for the physical features affected by these adjustments can be stored in the server memory for future use.

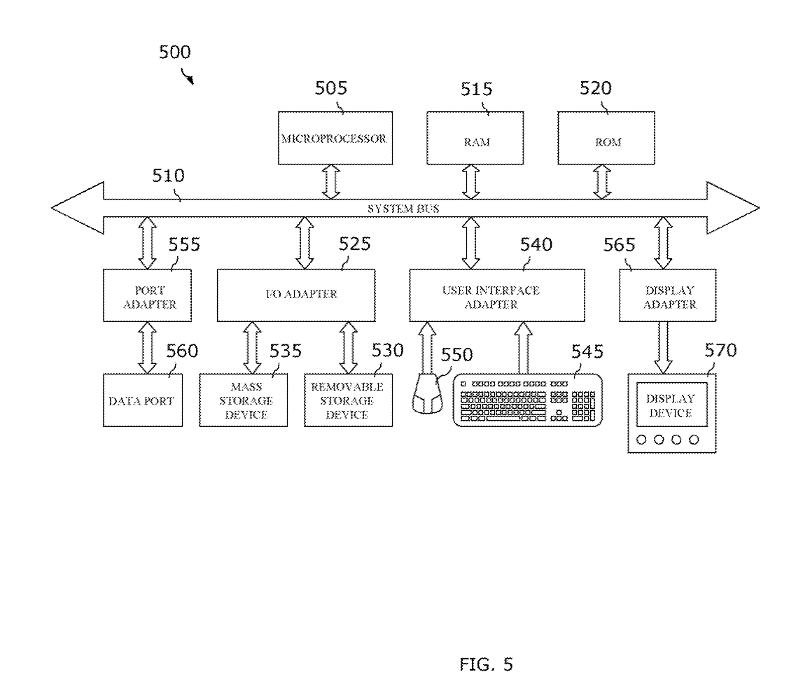

Generally, the method embodiments for implementing the adjusting of an office space for relatively “best” ergonomic positioning or comfort may be practiced with a general-purpose computer such as the server 112 (FIG. 1) or a computer located within the office space 100 and the method may be coded as a set of instructions on removable or hard media for use by the general-purpose computer. FIG. 5 is a schematic block diagram of a general-purpose computer suitable for practicing embodiments of the present invention. In FIG. 5, computer system 500 has at least one microprocessor or central processing unit (CPU) 505. CPU 505 is interconnected via a system bus 510 to a random access memory (RAM) 515, a read-only memory (ROM) 520, an input/output (I/O) adapter 525 for connecting a removable data and/or program storage device 530 and a mass data and/or program storage device 535, a user interface adapter 540 for connecting a keyboard 545 and a mouse 550, a port adapter 555 for connecting a data port 560 and a display adapter 565 for connecting a display device 570.

ROM 520 contains the basic operating system for computer system 500. The operating system may alternatively reside in RAM 515 or elsewhere as is known in the art. Examples of removable data and/or program storage device 530 include magnetic media such as floppy drives arid tape drives and optical media such as CD ROM drives. Examples of mass data and/or program storage device 535 include hard disk drives and non-volatile memory such as flash memory. In addition to keyboard 545 and mouse 550, other user input devices such as trackballs, writing tablets, pressure pads, microphones, light pens and position-sensing screen displays may be connected to user interface 540. Examples of display devices include cathode-ray tubes (CRT) and liquid crystal displays (LCD).

A computer program with an appropriate application interface may be created by one of skill in the art and stored on the system or a data and/or program storage device to simplify the practicing of tins invention. In operation, information for or the computer program created to run the present invention is loaded on the appropriate removable data and/or program storage device 530, fed through data port 560 or typed in using keyboard 545.

In view of the above, the present method embodiments may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described hereinabove and illustrated in FIGS. 1-4.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for earning out this invention, but that the invention will include all embodiments falling within the scope of the appended claims.

What is claimed is:

1. A method for adjusting components within an office space, comprising:
adjusting to a preferred setting at least one of a plurality of physical features of at least one of a plurality of the components for at least one of a plurality of persons;
storing the preferred setting for the at least one person;
identifying one of the persons from information about that person; and
for the identified person adjusting at least one of the physical features of at least one of the components to the preferred setting,

2. The method of claim 1, wherein the step of identifying one of the persons comprises identifying one of the persons using biometric information for that person.

3. The method of claim 1, wherein the step of adjusting to a preferred setting comprises automatically adjusting to the preferred setting at least one of the physical features of at least one of the components for at least one of the persons.

4. The method of claim 3, wherein the step of automatically adjusting comprises determining a position of at least one of the physical features of at least one of the components for at least one of the persons.

5. The method of claim 1, wherein the step of adjusting for the identified person comprises simultaneously automatically adjusting to the preferred settings a plurality of the physical features of a corresponding plurality of the components.

6. The method of claim 1, wherein the step of adjusting to a preferred setting comprises determining a position of at least one of the physical features of at least one of the components for at least one of the persons.

7. The method of claim 1, wherein the step of adjusting for the identified person at least one of the physical features of at least one of the components to the preferred setting comprises automatically adjusting to the preferred setting at least one of the physical features of at least one of the components for at least one of the persons.

8. A computer program product, comprising:
a computer readable computer program code for implementing adjusting of components within an office space; and
instructions for causing a computer to implement a method, the method further including:
adjusting to a preferred setting at least one of a plurality of physical features of at least one of a plurality of the components for at least one of a plurality of persons;
storing the preferred setting for the at least one person;
identifying one of the persons from information, about that person; and
for the identified person adjusting at least one of the physical features of at least one of the components to the preferred setting.

9. The computer program product of claim 8, wherein the step of identifying one of the persons comprises identifying one of the persons using biometric information for that person.

10. The computer program product of claim 8, wherein the step of adjusting to a preferred setting comprises automatically adjusting to the preferred setting at least one of the physical features of at least one of the components for at least one of the persons.

11. The computer program product of claim 10, wherein the step of automatically adjusting comprises determining a position of at least one of the physical features of at least one of the components for at least one of the persons.

12. The computer program product of claim 8, wherein the step of adjusting for the identified person comprises simultaneously automatically adjusting to the preferred settings a plurality of the physical features of a corresponding plurality of the components.

13. The computer program product of claim 8, wherein the step of adjusting for the identified person at least one of the physical features of at least one of the components to the preferred setting comprises automatically adjusting to the preferred setting at least one of the physical features of at least one of the components for at least one of the persons.

14. A system for adjusting components within an office space, the system comprising:
a computing network including a processing device in communication with one or more computer memory storage devices, and
the computing network further configured to implement a method for adjusting at least one of a plurality of the components within the office space, the method further including:
adjusting to a preferred setting at least one of a plurality of physical features of at least one of the plurality of the components for at least one of a plurality of persons;
storing the preferred setting for the at least one person;
identifying one of the persons from information about that person; and
for the identified person adjusting at least one of the physical features of at least one of the components to the preferred setting.

15. The system of claim 14, wherein the step of identifying one of the persons comprises identifying one of the persons using biometric information for that person.

16. The system of claim 14, wherein the step of adjusting to a preferred setting comprises automatically adjusting to the preferred setting at least one of the physical features of at least one of the components for at least one of the persons.

17. The system of claim 16, wherein the step of automatically adjusting comprises determining a position of at least one of the physical features of at least one of the components for at least one of the persons.

18. The system of claim 14, wherein the step of adjusting for the identified person comprises simultaneously automatically adjusting to the preferred settings a plurality of the physical features of a corresponding plurality of the components.

19. The system of claim 14, wherein the step of adjusting to a preferred setting comprises determining a position of at least one of the physical features of at least one of the components for at least one of the persons.

20. The system of claim 14, wherein the step of adjusting for the identified person at least one of the physical features of at least one of the components to the preferred setting comprises automatically adjusting to the preferred setting at least one of the physical features of at least one of the components for at least one of the persons.
